(19) United States
(12) Patent Application Publication
(10) Pub. No.: US 2007/0011244 A1
(43) Pub. Date: Jan. 11, 2007

(54) Arrangement for mobile communications and wireless publishing

(76) Inventors: Shawn O'Neal, Santa Rosa Beach, FL (US); John Edward Maier, Crystal Lake, IL (US)

Correspondence Address: GREENBERG TRAURIG, LLP, 77 WEST WACKER DRIVE, SUITE 2500, CHICAGO, IL, 60601-1732, US

(21) Appl. No.: 10/561,659

(22) PCT Filed: Jun. 18, 2004
(86) PCT No.: PCT/US04/19726

§ 371 Date: Jun. 26, 2006

Related U.S. Application Data
(60) Provisional application No. 60/479,560, filed on Jun. 18, 2003.

(51) Int. Cl. G06F 15/16

(52) U.S. Cl. 709/206

(57) ABSTRACT

A wireless communication system for transmission of digital messages to users of wireless communication devices (600, 610, 620, 630, 640, 650) on various wireless networks (500, 510, 520, 530, 540, 550) is provided. Messages to users are encoded with formatting corresponding to the network and/or subscriber device to which a message is to be delivered. A digital content server (100) can operate to create, encode and transmit messages to users of a plurality of different wireless networks (500, 510, 520, 530, 540, 550).

### BACKGROUND OF THE INVENTION

The present invention relates in general to wireless communications, and specifically to the transmission of digital messaging to users of wireless communication networks.

FIG. 1 illustrates a prior art system for digital messaging in a mobile communications environment which includes numerous wireless service providers. Digital messaging is commonly implemented in the wireless communication environment using the SMS (Short Messaging System) standard. Wireless service providers typically operate a SMS server configured to handle SMS messaging, such as SMS servers 10, 20, 30, 40, 50 and 60. A SMS server receives SMS messages from mobile telephone users of its affiliated wireless service provider, and transmits SMS messages to that service provider's mobile telephone users.

When digital messages are conveyed between a mobile telephone user, and another entity outside of the network operated by the mobile telephone user's service provider, such messages are typically conveyed using MIME (Multipurpose Internet Mail Extensions) formatting. The MIME format is intended to provide standard mechanisms for transmitting digital content. Thus, service providers typically provide a MIME server configured to translate digital messages between a service providers designated formatting, and a format based upon MIME standards. The communication system of FIG. 1 includes MIME servers 11, 21, 31, 41, 51 and 61.

However, because MIME does not govern all aspects of formatting and content for digital messaging, and because wireless service providers may use varying MIME translations to and from their designated messaging protocols within their own networks, implementation of MIME does not ensure identical handling of digital messages by each wireless service provider. Thus, the formatting and content of digital messages can be altered or lost during conversion processes as messages are communicated to and from users on different networks.

Therefore, it would be desirable to provide a wireless messaging system capable of transmitting messages to users of multiple different wireless communication networks. It would further be desirable to ensure that formatting and content of such messaging is optimized for each user, regardless of the wireless network through which the messages are delivered. It would also be desirable to provide a powerful and flexible messaging platform capable of conveying potentially complex and interactive communications to users of wireless devices. Some of these and other features may be provided through implementation of various aspects of the present invention.

### BRIEF DESCRIPTION OF THE DRAWINGS

FIG. 1 is a block diagram of a prior art wireless messaging platform.

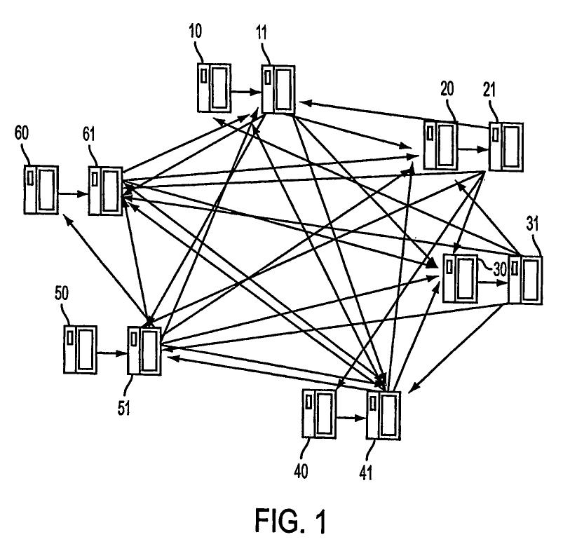

FIG. 2 is a block diagram of a wireless communication system according to one aspect of the present invention.

FIG. 3 is a flowchart illustrating a method of operation for a wireless communication system.

FIG. 4 is a flowchart illustrating the generation of a digital message.

FIG. 5 is a screenshot illustrating a user profile stored within a digital content server.

FIG. 6 is a screenshot illustrating configuration of a recipient group for digital messaging.

FIG. 7 is a screenshot illustrating association of a user profile with predetermined recipient groups.

FIG. 8 is a screenshot providing for creation of message content.

FIG. 9 is a screenshot illustrating a mechanism for identifying message recipients.

FIG. 10 is a flowchart illustrating a technique for transmitting messages.

FIG. 11 is a screenshot of a further message configuration utility.

FIG. 12 is a screenshot illustrating the creation of a web page.

FIG. 13 is a screenshot further illustrating the creation of a web page.

FIG. 14 is a screenshot illustrating the configuration of security settings.

FIG. 15 is a screenshot of a message configuration tool providing for transmission of messages with embedded graphic images.

FIG. 16 is a screenshot of a further configuration tool interface according to another aspect of the invention, providing for review of sent messages.

FIG. 17 is a screenshot illustrating an interface for the development and transmission of interactive quizzes.

FIG. 18 is a screenshot indicating results from transmission of an interactive quiz.

FIG. 19 is a screenshot displaying a designated user's response to an interactive quiz.

FIG. 20 is a screenshot of an interface for adding user profiles to a digital content server.

FIG. 21 is a screenshot further indicating information within a user profile.

FIG. 22 is a screenshot illustrating the generation of hierarchical web pages.

FIG. 23 is a further screenshot illustrating the generation of hierarchical web pages.

### DETAILED DESCRIPTION OF THE DRAWINGS

While this invention is susceptible to embodiment in many different forms, there are shown in the drawings and will be described in detail herein several specific embodiments, with the understanding that the present disclosure is to be considered as an exemplification of the principle of the invention and is not intended to limit the invention to the embodiments illustrated.

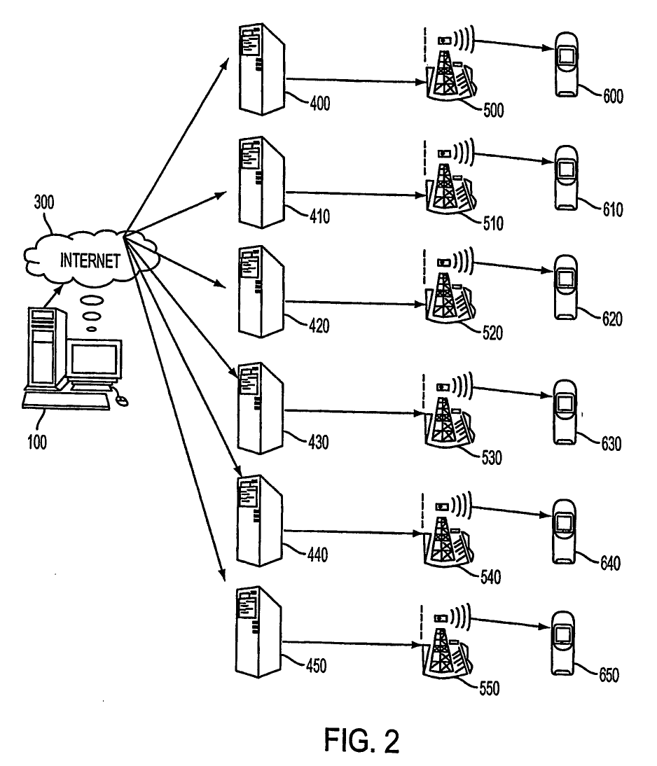

FIG. 2 illustrates a communication system according to one aspect of the present invention which provides consistent and reliable digital messaging capabilities for communications with mobile telephone subscribers using multiple different wireless service providers. The communication system implements advanced messaging functionality that is interoperable across a wide variety of wireless communication platforms and standards, and subscriber hardware. For example, the system can provide advanced text messaging across a large number of different wireless service provider networks, using a combination of SMS and wireless Internet protocols implemented by many so-called “2G” cellular telephones, and substantially all “2.5G” and “3G” cellular telephones.

The communication system of FIG. 2 includes digital content server 100. Digital content server 100 can be configured to implement both MIME server and SMS server functionality, as well as other functionality. Digital content server 100 enables digital messaging with mobile telephones 600, 610, 620, 630, 640 and 650, which mobile telephones communicate with cellular networks 500, 510, 520, 530, 540 and 550, respectively. Of course, while the system of FIG. 2 is illustrated having mobile telephones 600-650 as subscriber devices, it is understood that other types of subscriber units (two-way pagers, PDAs, integrated telephone/PDAs, etc.) could also readily be employed. In the embodiment of FIG. 2, each cellular network 500-550 is operated by a different wireless service provider. Each wireless service provider operates an SMS (Short Messaging System) server. Each of SMS servers 400, 410, 420, 430, 440 and 450 are capable of communicating with Internet 300, as well as the cellular networks with which they are associated. The SMS servers enable mobile telephone users to transmit and receive short digital messages, thus providing non-voice communication capabilities to mobile telephone users.

In addition to being configured for communication with their associated wireless networks, the SMS servers are configured for communication with Internet 300 by employing MIME formatting for the digital content communicated thereon. Thus, the servers can receive messaging in a MIME format from Internet 300, allowing for transmission of email and other digital messaging from sources outside of the wireless network with which each proprietary SMS server is associated. Outbound digital content can be sent through a service provider MIME server (not shown) to enable MIME-enabled recipients to receive and properly decode digital content generated by mobile users.

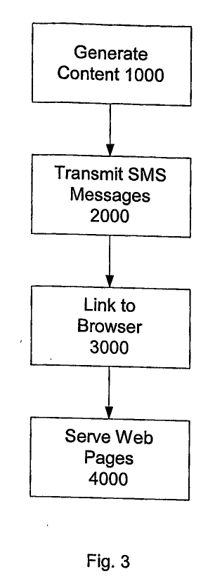

One technique for digital messaging that can be implemented using digital content server 100 according to another aspect of the invention is illustrated in the flowchart of FIG. 3. First, digital messaging content is generated in step 1000. Next, SMS messages are transmitted by digital content server 100, step 2000. The SMS messages are conveyed to mobile telephone subscribers, and may be used to invoke a subscriber's wireless web browser, step 3000. Finally, further messaging can be provided through service of digital content as web pages, step 4000.

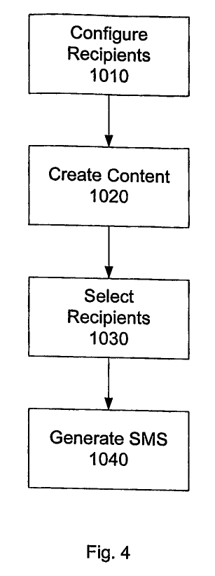

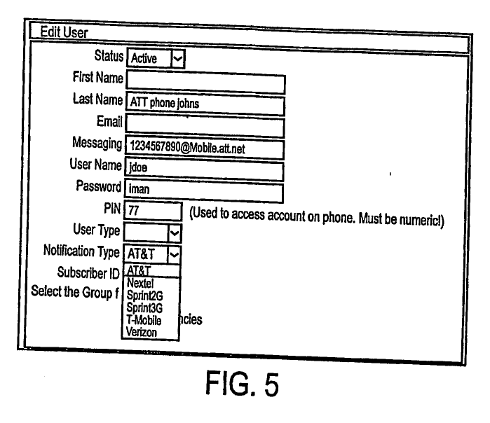

One embodiment of step 1000 for generating digital messaging content is further illustrated in the flowchart of FIG. 4. Initially, recipients are configured in step 1010. FIG. 5 illustrates a screen providing for the configuration of a message recipient. Fields are provided to store information regarding a user, including the user's name, email address, digital messaging address, user name, password, security PIN code, user type, notification type and subscriber ID. The user can be further designated as Active or Inactive.

The user's Notification Type designation can be used to determine the formatting rules that are employed when messages to that user are MIME-encoded. Digital content server 100 is configured with information describing specific MIME formats used by various wireless service providers. By custom encoding user messages for the specific MIME formatting employed by the message recipient's wireless service provider, the user can be assured of reliably receiving digital messages having consistent and optimal layout and display of the message content. When a recipient profile is configured in step 1010, digital content server 100 can be configured to examine the domain name extension of the recipient's digital messaging address. If the domain name extension is recognized as being associated with a MIME format for which the digital content server is configured, the Notification Type corresponding to the address domain name extension is automatically selected.

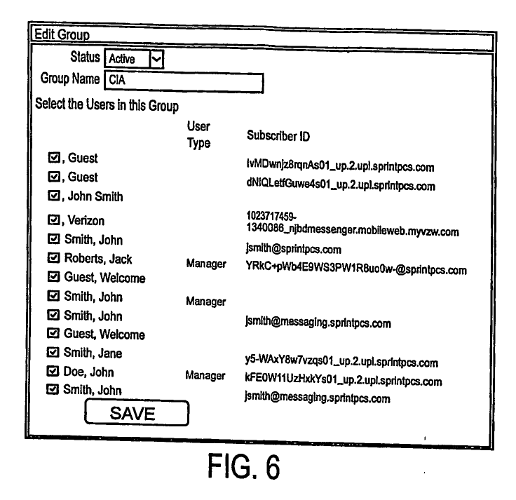

Content server 100 may also provide for configuration of recipient groups, allowing convenient preparation and transmission of digital messaging to predetermined sets of recipients. FIG. 6 illustrates a group configuration feature of content server 100, according to one aspect of the invention. A Group Name can be defined, and a plurality of users can be selected as group members. Furthermore, the entire group can be designated as Active or Inactive.

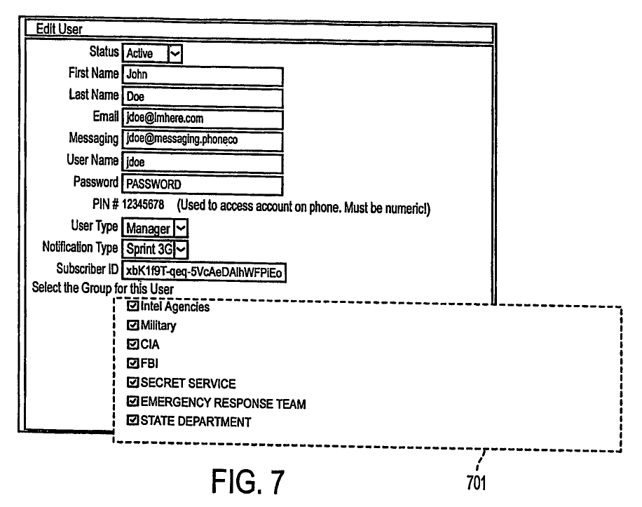

According to another aspect of the invention, group membership may also be configured on an individual recipient basis, via the recipient configuration screen of FIG. 7. A plurality of group names are displayed in region 701. The recipient can be included in, or excluded from, each group through selection or deselection of the check box associated with each group name.

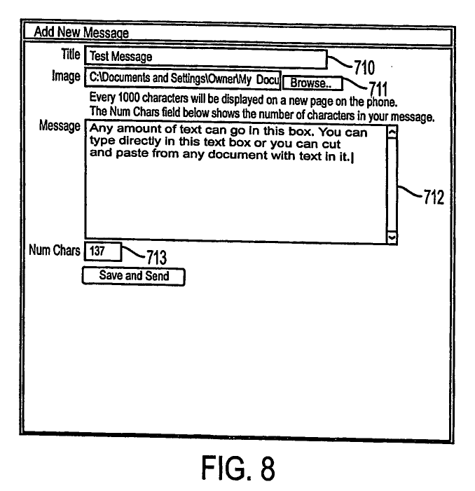

Once individual recipients, and optionally group recipients, are configured, digital messaging content can be created, step 1020 (FIG. 4). A content creation mechanism according to one embodiment of the invention is illustrated in FIG. 8. The content creation screen of FIG. 8 supports both text and image content. Field 710 is provided for identification of a message title. Field 711 allows for the incorporation of image data into the message under composition. Finally, text content can be added to field 712, either via manual entry of the desired text or via automated cutting and pasting of content from other applications. Field 713 provides an automated count of the number of characters of text present within field 712, providing feedback regarding the size of the message that is being created. However, the size of the message entered into field 712 need not be restricted by a predetermined maximum length.

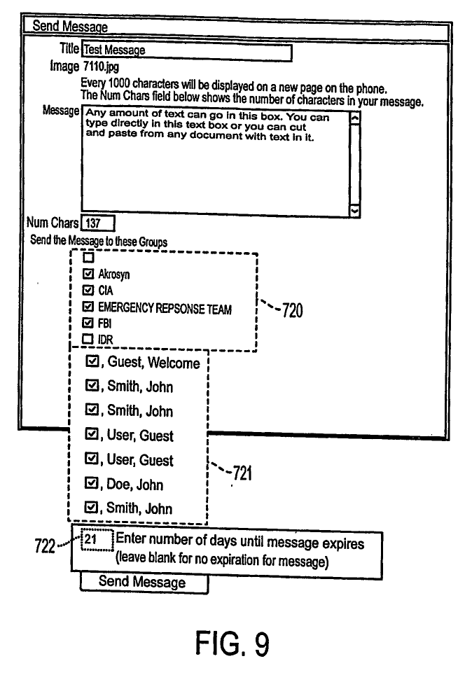

Once a message has been created, the message recipients can be identified, step 1030 (FIG. 4). The screen of FIG. 9 provides a mechanism for identifying recipients, according to another aspect of the invention. Predetermined groups of recipients can be selected using the group selection region 720. Also, individual recipients can be selected using the individual selection region 721.

According to yet another aspect of the Invention, messages can be provided with various expiration options to provide a system administrator with enhanced control over message management. Typical prior art SMS servers are configured to maintain messages on the server for a predetermined period of time. However, field 722 allows for the determination of a message expiration period which can be individually set for each message that is composed. Thus, for example, important messages can be configured to be maintained for extended periods of time, while unimportant messages can be quickly deleted. This allows for optimal employment of server storage resources. Also, a read-once expiration option causes a message to be automatically deleted immediately after the message has been read. Such a read-once option may be useful for security purposes, towards ensuring that messages are destroyed after receipt and not unnecessarily available for unauthorized access.

Once recipients are selected, SMS messages are generated for each recipient, step 1040. Initially, a message is created for each recipient that includes a wireless web link that can be accessed by the recipient. The link generated for each recipient can be uniquely associated with the corresponding message content, thus enabling subsequent retrieval of message content by content server 100 when the recipient accesses the link. The formatting and content of the wireless web link sent to each user depends upon the MIME requirements of the service provider associated with the message recipient.

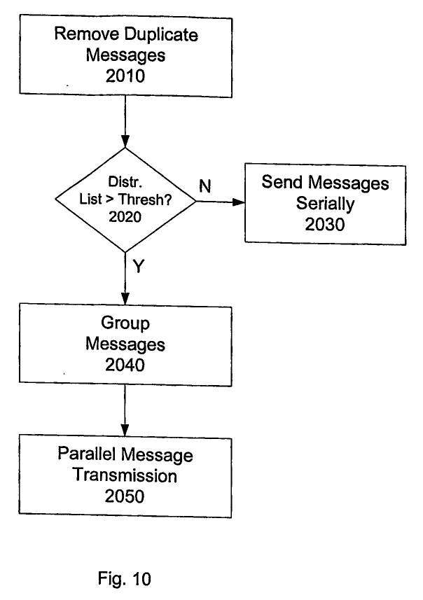

Once generated, the SMS messages are transmitted, step 2000 (FIG. 3). According to another aspect of the invention, a technique for transmitting the messages is illustrated in the flowchart of FIG. 10. Duplicate messages are removed in step 2010. Duplicate messages may be generated when a message identifies a particular individual recipient more than once, such as when a message is sent to a specific individual user as well as one or more groups of which that same user is a member. By searching for and removing duplicate messages in step 2010, care is taken to avoid transmission of the same message to a particular recipient more than once.

After any duplicate messages are removed, content server 100 evaluates the size of the message distribution list to determine a desired technique for sending the messages, step 2020. If the size of the distribution list is below a predetermined threshold (i.e. 10,000 users), then the load imposed on the server to transmit the messages is sufficient low that the messages can be rapidly and reliably transmitted in a serial fashion, step 2030. However, when the server requirements for transmitting the messages exceed a given threshold, alternate message transmission techniques can be employed (e.g. steps 2040 and 2050). In step 2040, messages are grouped for delivery based upon various attributes. For example, messages may be grouped by one or more of a variety of attributes, including by: the recipients' wireless service providers, alphabetically by recipient name, by title, geographic area, or any designation that may be captured within the user database. The messages can then be sent out in a parallel fashion by multiple servers, step 2050, whereby each grouping is routed to a different server. Such parallel transmission facilitates more rapid message transmission and potentially more efficient data routing.

Whether sent out serially by a single server, or in a parallel manner, the messages are routed via Internet 300 (FIG. 2) to wireless service provider SMS servers 400-450. The messages are then conveyed via wireless service provider networks 500-550, to mobile phone users 600-650.

Once a SMS message is received by a subscriber's cellular telephone, the recipient can read the SMS message, thereby causing the subscriber unit to automatically access the wireless Internet link, step 3000 (FIG. 3). The subscriber unit then uses integrated wireless web browser functionality to access the message content from digital content server 100 as a series of web pages, step 4000. Messaging content can be conveyed to the subscriber unit using WML (Wireless Markup Language). Alternatively, subscriber unit web browsers may utilize standards such as WAP (Wireless Application Protocol), WML (Wireless Markup Language), HDML (Handheld Device Markup Language) and/or XHTML (Extensible HyperText Markup Language) to display the messaging content.

Content server 100 converts the unlimited-length message contents, including text and optionally graphics, into a series of web pages that can be navigated by the subscriber. The web pages are then automatically served from content server 100. By providing messaging by using a recipient's web browser functionality rather than SMS, limitations on message length that are imposed by SMS messaging can be avoided. After a full web page of message text and/or graphics has been displayed to the subscriber, a “MORE” link is provided to initiate retrieval of the next of an arbitrary number of pages of message content, analogous to turning the pages of a book. Also, by utilizing web browser functionality of a subscriber device, images can be integrated with text in a common message.

According to another aspect of the invention, content server 100 can apply security features to its messaging. In creating a message, user authentication can optionally be required to assist in preventing unintended individuals from viewing the message contents. Content server 100 can store the subscriber ID of each user, as well as a PIN code. The subscriber ID is typically used by wireless service providers for tracking network usage, maintaining billing records and sometimes for certain security purposes. The subscriber ID is typically a 12 digit alphanumeric code that is uniquely assigned to a given subscriber, and stored within the cellphone assigned to the subscriber.

A PIN code can also be stored within content server 100 and associated with each user. The PIN code is preferably a numeric code of approximately 10 digits in length. The PIN code can be assigned to each user by the administrator of content server 100.

Upon receiving a request to transmit message content, digital content server 100 examines the subscriber ID and the PIN code received from the requesting subscriber in conjunction with the request. If the subscriber ID and PIN code do not correspond to known values for a recipient of the requested message, then the message request is denied and no message content is transmitted.

An additional level of security can be provided by associating a password demand with a given message during the message configuration process. If a message is password protected, content server 100 initially returns a password query after the subscriber initiates the web link from the initial SMS message that is received by the subscriber. If the subscriber does not respond by providing the password associated with the subscriber, then access to the message contents is denied.

By using the Subscriber ID and PIN code for authentication, a user can readily upgrade subscriber hardware while maintaining the same service provider without causing an interruption in messaging service and without requiring manual intervention on the part of the operator of digital content server 100. This is because the Subscriber ID stays with the subscriber, and would be programmed into any new subscriber hardware to which a user may upgrade. Also, if a corporation or other entity provides wireless service for a subscriber, that subscriber will no longer be able to use the messaging system once the sponsoring organization closes an account, since the subscriber would receive a new Subscriber ID even when keeping the same cellphone and/or the same wireless service provider.

Also, the authentication procedures described herein prevents an unauthorized individual who learns of the PIN code and/or password of a messaging subscriber from accessing messages on digital content server 100 using a different subscriber unit, since the unauthorized user's Subscriber ID would not correspond to the Subscriber ID stored within content server 100. Also, when an account is designated INACTIVE within the Status field of the user configuration stored by content server 100, the associated Subscriber ID is blocked from accessing messaging and web-based content.

A final level of security can be provided on a link-by-link basis within a message having multiple links or menu options. In generating a message, various options and links can optionally be configured for access by only specified users. When transmitting the message content, content server 100 adapts the transmitting content based upon the content that is available to the requesting user. Thus, the subscriber unit of a user who is not authorized to access a particular link will not display the unauthorized link. An operator of content server 100 can dynamically maintain the list of authorized users for each link to control access to specific information at any given time. Additional security can be provided by implementing encryption techniques to encrypt the data that is transmitted between content server 100 and a wireless subscriber, towards preventing interception of transmitted information by unauthorized individuals.

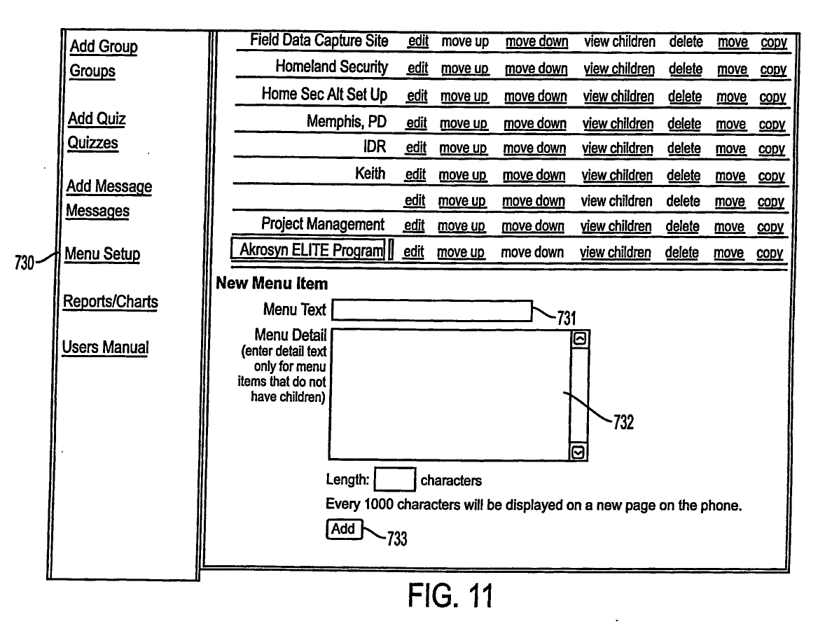

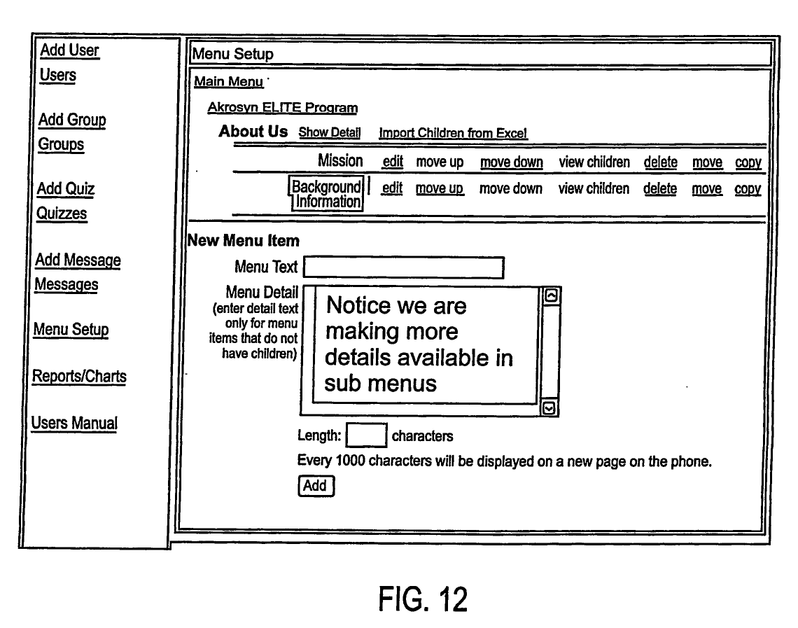

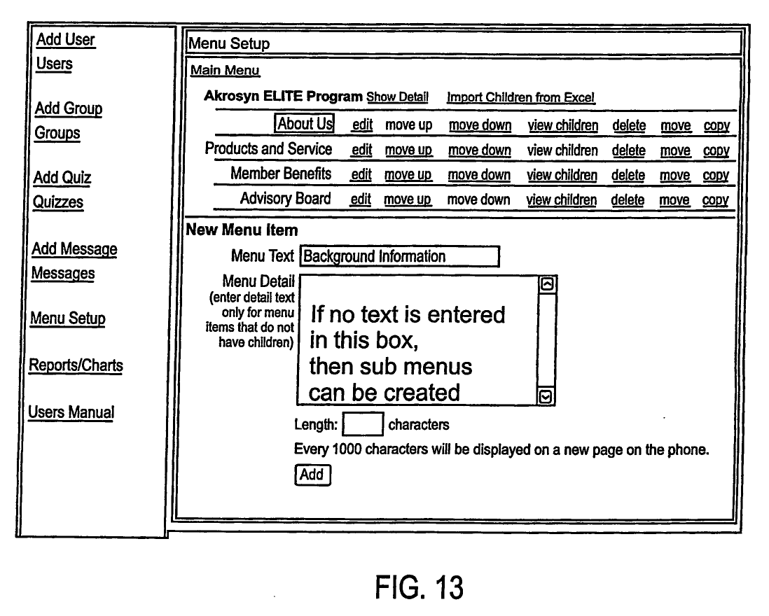

According to another aspect of the present invention, content server 100 also provides a software interface through which message content and wireless web pages can be quickly and easily configured. The interface provides for assembly of hierarchical information structures. For example, FIG. 11 illustrates one aspect of such a message configuration utility. After selecting “Menu Setup” option 730, an operator can enter the name of a menu selection in Menu Text field 731. Menu text labels can be configured in a hierarchical organization. At the lowest hierarchy levels, information can be provided in Menu Detail field 732. Information can be entered into Menu Detail field 732 manually, or by cutting and pasting content from other applications. Once a menu label or detail item is configured, Add button 733 can be selected to add the new item to the web page under construction. FIGS. 12 and 13 illustrate the creation of a web page using the configuration tool, having a top-level menu called “Akrosyn ELITE Program”, with four selections designated “About Us,” “Products and Services,” “Member Benefits,” and “Advisory Board.”

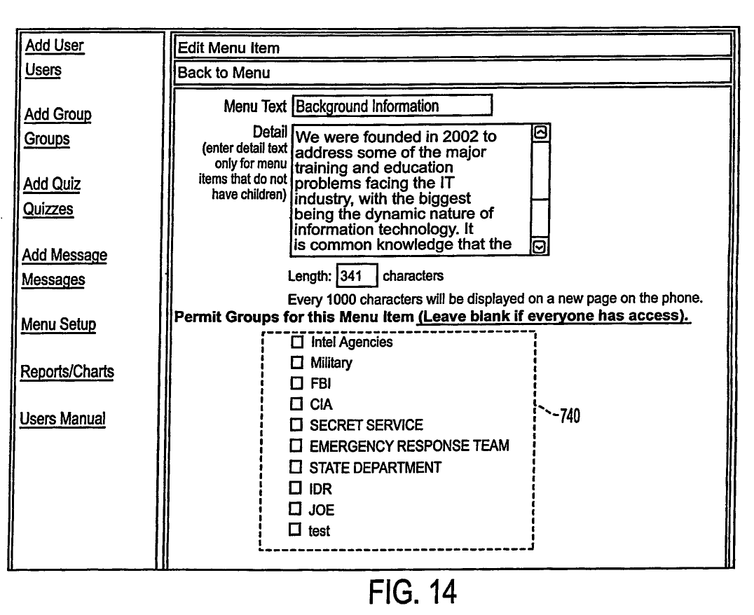

Security settings can be optionally applied to each menu item, through the interface of FIG. 14. Access to the selected menu item can be restricted to selected users and groups by selecting authorized users and/or groups within region 740. If no users or groups are selected, the menu item is available to all users.

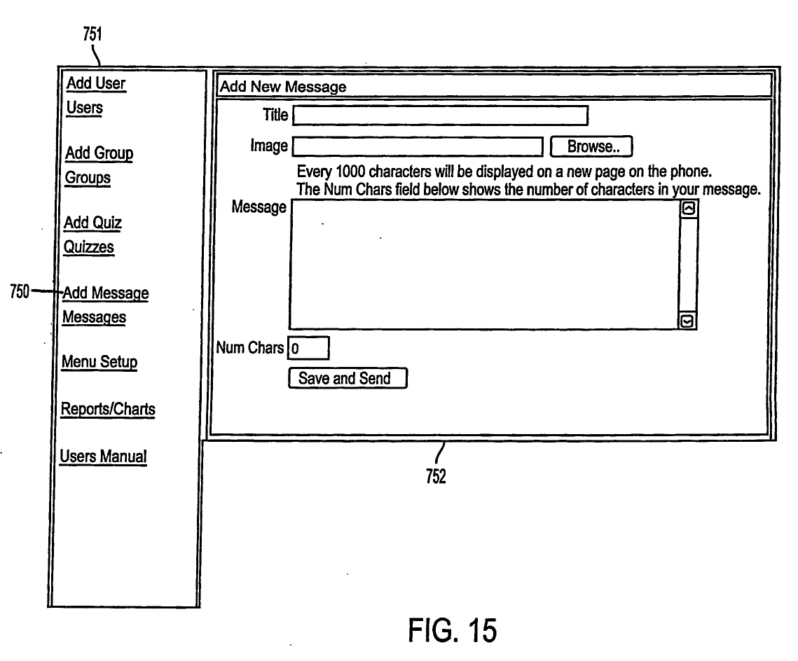

The message configuration tool also provides for transmission of messages with embedded graphic images through the interface illustrated in FIG. 15. Add Message selection 750 can be chosen from configuration tool selection bar 751, to initiate message configuration window 752. Window 752 can be used to create and transmit a message, as previously described in connection with FIGS. 8-9.

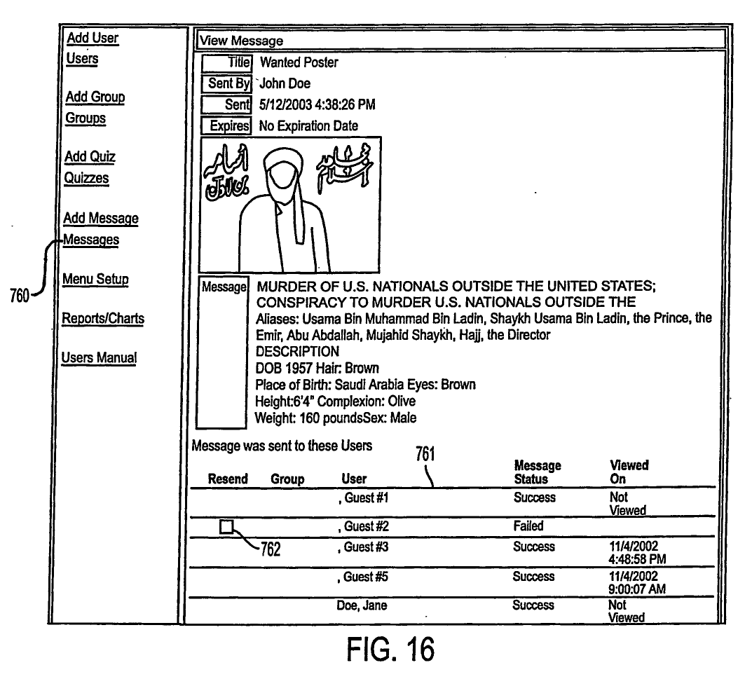

Sent messages can be reviewed by selecting “Messages” option 760 on the configuration tool interface of FIG. 16. Information regarding a sent message is displayed, including title, sender, date and time sent, expiration date and message contents. Also, region 761 identifies the status of delivery attempts for the displayed message. For each user name, information is provided indicating whether the message was successfully delivered, and if so, the date and time at which the message was viewed by the recipient, if at all. When message delivery fails, Resend selection item 762 is provided to initiate retransmission of the message to the associated user.

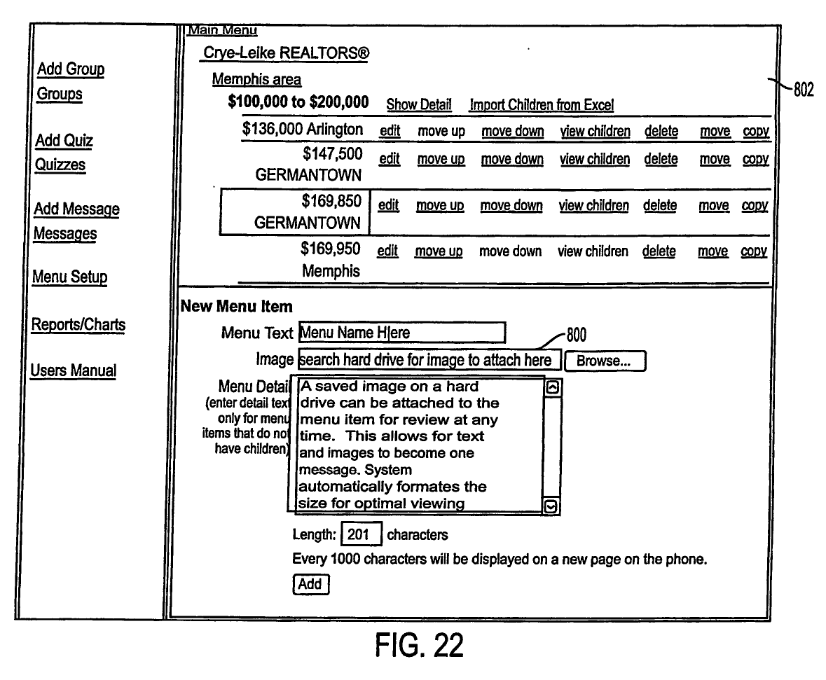

In accordance with another aspect of the invention, content server 100 can generate hierarchical web pages having both text and graphic images embedded within them. Such integration of unlimited text and graphics in a hierarchical data structure enables ready publication of information to users of wireless phones and like devices. FIG. 22 illustrates the application of such a feature in the context of the wireless publication of real estate listings. The hierarchical publication is generally created in a manner analogous to that of the text-based documents illustrated in FIGS. 12-13. However, additional field 800 is provided, allowing for the selection of one or more graphic images to be associated with the menu item being defined. Thus, in region 802, a plurality of menu items are created, in which each menu item is associated with a property for which a real estate listing is available. A photograph of the property can then be associated with each real estate listing, enabling a potential buyer to view the property via a wireless telephone.

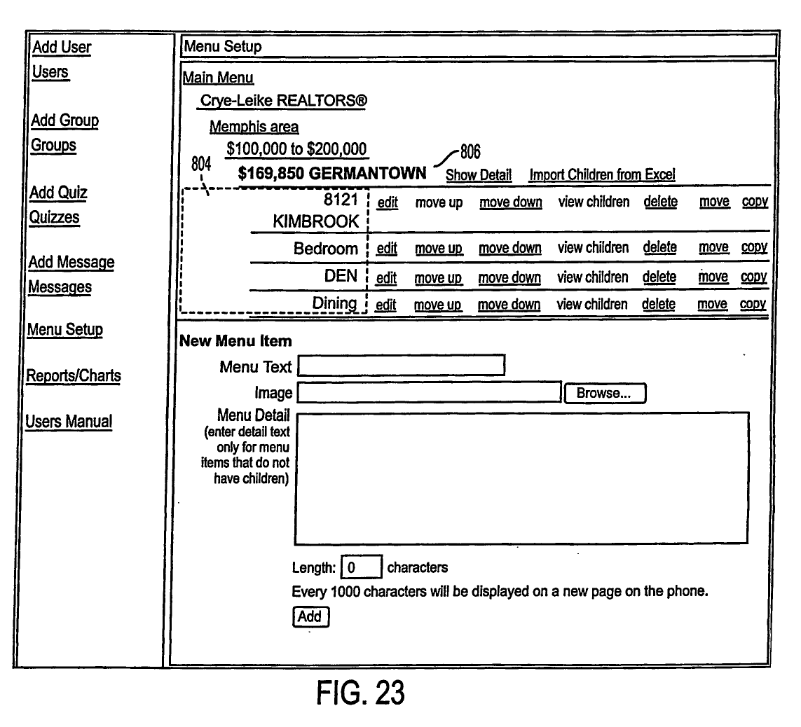

For each menu item (representing, in this case, a property listing), subsidiary menu items can be created beneath each property listing item, providing further information about the property. For example, in FIG. 23, additional sub-menu items are provided within region 804 indicating, for property listing 806, the street address of the listing, and various rooms within the house on the property. One or more graphic images can be associated with each room sub-menu item through use of field 800, providing a digital photograph of the room. Once created, the hierarchical web page with integrated graphics and images can be navigated by a wireless telephone or like device, as illustrated in FIG. 24. In addition to real estate listings, such web pages can be used to publish other types of documents and/or information, including magazine articles with photos and/or diagrams, to users of cellular telephones.

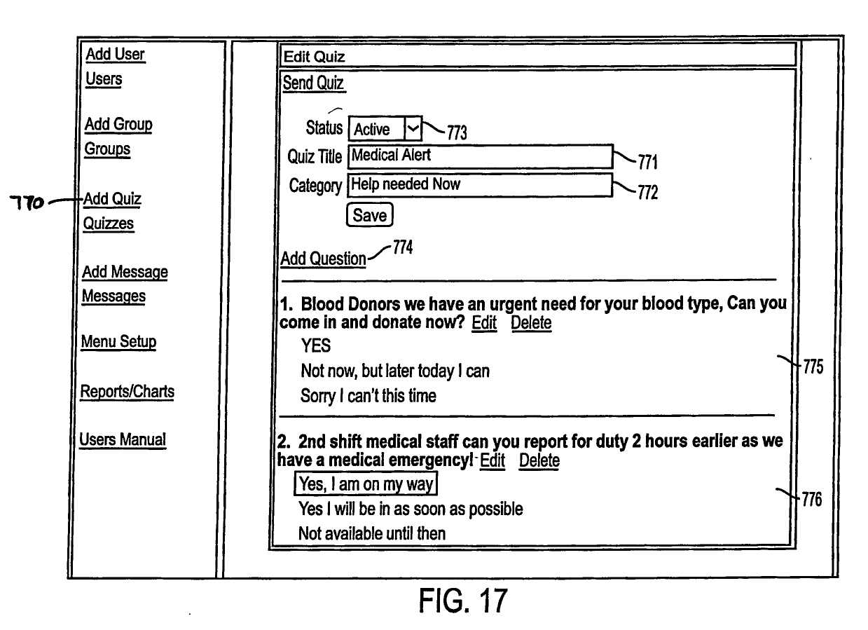

According to another aspect of the invention, the message configuration tool can also be used to develop and transmit interactive quizzes to users via the interface of FIG. 17. Option 770 can be selected in the configuration tool selection bar to generate a new quiz message. The Quiz Title and Category are entered in fields 771 and 772, respectively. The quiz can be designated as Active or Inactive via Status field 773. Region 774 can be selected to add a question to the quiz under development. For each question, multiple possible answers can be specified. Examples of quiz questions are illustrated in regions 775 and 776. Once a quiz question is designed, it can be transmitted analogously to the messages providing text and/or graphics, discussed above. However, when a subscriber receives and activates a SMS link, the recipient's subscriber unit retrieves web pages displaying the quiz questions and requesting responses from the recipient.

Responses to quiz questions are received and tabulated by content server 100. Optionally, a message can be sent to the quiz recipient after the recipient's responses are received, towards providing feedback to the user regarding his or her answers. For example, in the case of an opinion poll, content server 100 can transmit a web page to the user indicating a summary of answers received by other users. If the quiz questions are objective, having correct and incorrect answers, content server 100 can transmit a web page to the user indicating what the correct answers were, and how many questions were answered correctly and/or incorrectly.

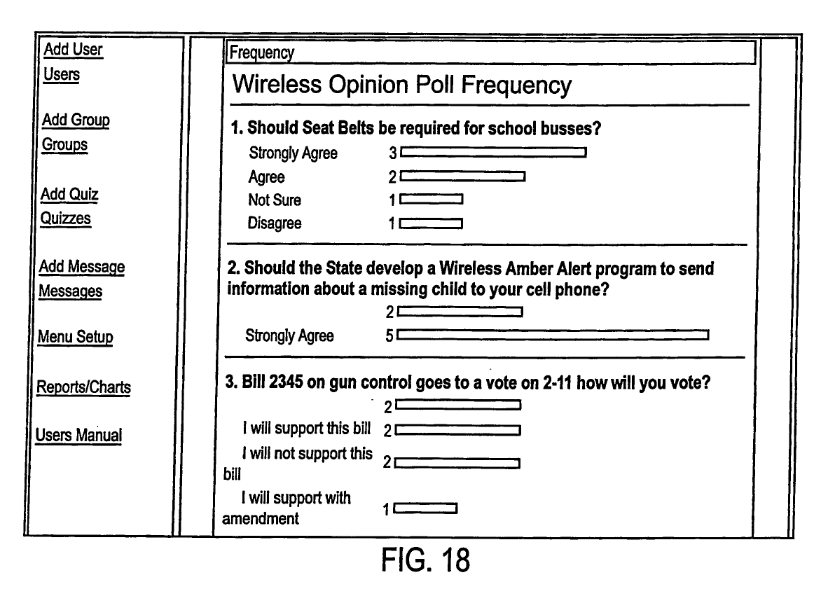

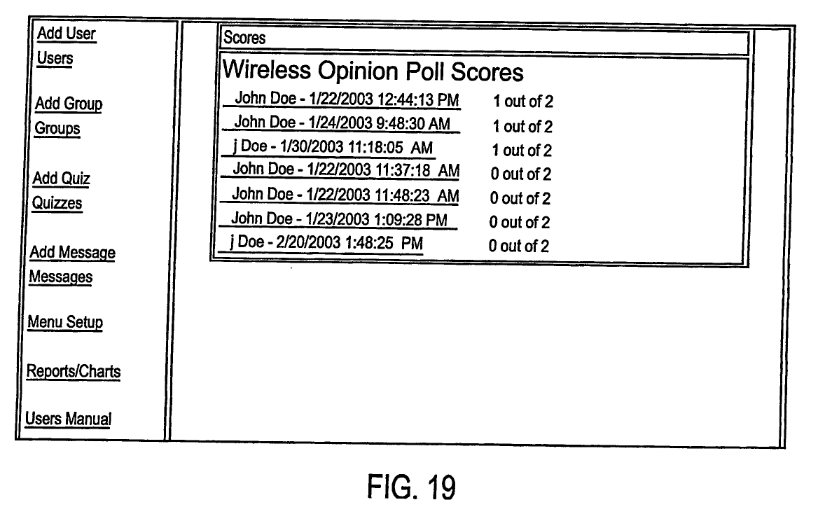

Content server 100 also provides an interface by which quiz results can be analyzed. FIG. 18 illustrates a display indicating the responses received for each quiz. Also, FIG. 19 illustrates a display whereby a designated user's specific quiz answers can be displayed.

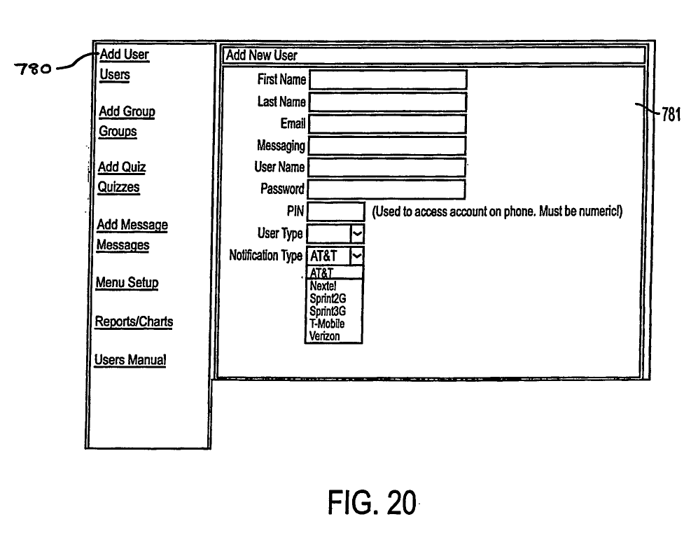

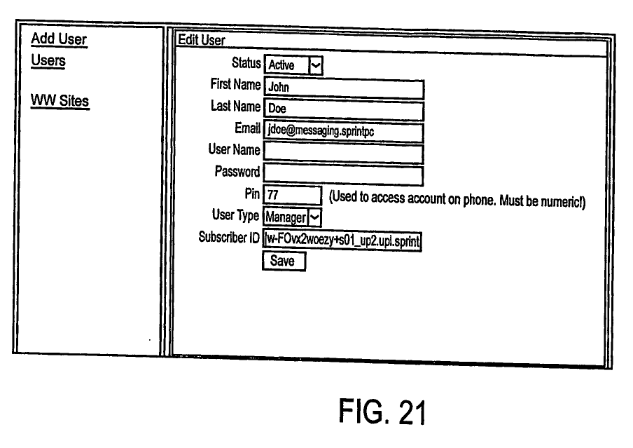

According to another aspect of the invention, the message configuration tool also provides an interface to add new users to the system, illustrated in FIG. 20. The addition of a new user is initiated through selection of item 780 within the configuration tool selection bar. User information is entered into fields within region 781, as described previously in connection with FIGS. 5-7. Once a user accesses content server 100 for the first time, the user's Subscriber ID is captured and populated within a content server database. The Subscriber ID and other security information can subsequently be viewed and edited through the interface of FIG. 21.

The foregoing description and drawings merely explain and illustrate the invention and the invention is not limited thereto, inasmuch as those skilled in the art, having the present disclosure before them will be able to make modifications and variations therein without departing from the scope of the invention.

I claim:

1. A method for transmitting digital messaging to users each associated with one of one or more wireless communication networks capable of receiving MIME encoded messages directed to network users, the method comprising the steps of:
configuring profiles for the one or more users, each profile containing a notification type designation;
generating message content;
encoding the message content using MIME encoding rules selected from amongst a plurality of MIME encoding rules based at least in part upon the notification type designation associated with a user to which the message is directed;
transmitting the encoded message content to the user to which the message is directed.

2. The method of claim 1, in which the profiles for the one or more users further contain a user address, and the step of configuring profiles for the one or more users further comprises the step of selecting a notification type designation based upon the user address.

3. The method of claim 1, in which the step of configuring profiles for the one or more users further comprises the step of selecting a notification type designation based upon the wireless communication network with which each user is associated.

4. The method of claim 1, in which the step of configuring profiles for the one or more users further comprises the step of selecting a notification type designation based upon a domain name associated with the user address.

5. The method of claim 1, in which the step of transmitting the encoded message content is comprised of the step of transmitting the encoded message content via the Internet.

6. The method of claim 1, in which the step of transmitting the encoded message content is comprised of the step of transmitting the encoded message content via a Short Messaging System protocol implemented by the wireless communication network associated with the user to which the message is directed.

7. The method of claim 5, in which the message content includes a web browser link that can be implemented by the user to obtain further information using a web browser on a wireless subscriber device at which the message content is received.

8. The method of claim 1, in which the message content is encoded and transmitted to a plurality of users, whereby each user receives the message content encoded using MIME encoding rules corresponding to the wireless network with which each user is associated.

9. The method of claim 7, the method further comprising the step of transmitting one or more web pages to the user in response to implementation by the user of the web browser link.

10. The method of claim 9, in which the step of transmitting one or more web pages to the user is comprised of the step of first verifying the identity of the user implementing the web browser link, whereby the one or more web pages are not transmitted unless and until the identity of the user is verified.

11. The method of claim 10, in which the step of verifying the identity of the user implementing the web browser link is comprised of the step of comparing an identification field associated with the user requesting the web pages to an identification field stored within the profile associated with the user to whom the web link was transmitted.

12. The method of claim 10, in which the identification field is comprised of one or more of a subscriber ID value and a Personal Identification Number.

13. The method of claim 9, in which the step of transmitting one or more web pages to the user is comprised of the step of first interrogating the user for entry of a predetermined password, whereby the one or more web pages are not transmitted unless and until the user correctly enters the predetermined password.

14. The method of claim 9, in which the one or more web pages comprise a quiz requesting information from the user, the method further comprising the steps of:
receiving the information from the user in response to the quiz;
transmitting a feedback web page to the user, the contents of which are determined based at least in part upon the information received from the user in response to the quiz.
